(19) United States
(12) Patent Application Publication
(10) Pub. No.: US 2015/0058175 A1
(43) Pub. Date: Feb. 26, 2015

(54) REALIZING BOXED EXPERIENCE FOR DIGITAL CONTENT ACQUISITION

(71) Applicant: Microsoft Corporation, Redmond, WA (US)

(72) Inventors: Peter Axt, Kirkland, WA (US); Matthew Wan, Redmond, WA (US); Brandon Hunt, Redmond, WA (US)

(73) Assignee: Microsoft Corporation, Redmond, WA (US)

(21) Appl. No.: 13/971,846

(22) Filed: Aug. 21, 2013

(51) Int. Cl. G06Q 20/12

(52) U.S. Cl. CPC G06Q 20/123
USPC 705/26.81

(57) ABSTRACT

Example apparatus and methods concern realizing the boxed experience for digital content acquisition. Example apparatus and methods associate a digital content purchase with digital metadata. The digital content purchase may be a computer game, a console video game, a film, a television program, or an e-book. The digital metadata may describe a user-customizable physical item portrayed within the digital content purchase. Example apparatus and methods include digital metadata with a digital content purchase, and control the re-creation of a physical item from the digital metadata. Example apparatus and methods may limit the number of times the physical item may be re-created from the digital metadata, and may control the frequency with which the physical item may be re-created.

### BACKGROUND

People who purchase physical copies of digital content in brick and mortar stores often enjoy a different shopping experience than people who purchase digital content online for direct download. Before the Internet was as pervasive and developed as it is today, purchasers of computer games would frequently visit a specialized brick and mortar computer game store to purchase boxed copies of computer games. Similarly, purchasers of console video games would also visit specialized stores to purchase boxed copies of game cartridges, compact disks (CD), and so on. Other content was often delivered to customers at specialized stores. For instance, records, tapes, and CDs were purchased at record stores. Copies of films and television programs on video tape and digital versatile disk (DVD) were frequently purchased at dedicated video stores. Books, comic books, and graphic novels, along with associated paraphernalia, were available at specialty book and comic shops. In addition to purchasing hard copies of their digital media content, customers were able to meet and discuss their purchases with similar like-minded individuals at their local computer game shop or record store.

With the development of the Internet, shopping patterns for digital content changed. Brick and mortar stores have increasingly been replaced with online sales. The computer game shop is largely a thing of the past, as is the local video store and the record store. Digital content in the form of computer games, console video games, films and television programs, and music are now frequently delivered to customers via the Internet. Computer gamers may navigate to the website of a computer game publisher, purchase a digital copy of a game, and download that game to their personal computer. Similarly, console gamers may purchase or rent digital copies of video games from their game consoles. In the situations of the computer and console gamers, these users rarely obtain a physical copy, for example a CD or DVD of the purchased game. Similarly, the social aspect of visiting the local computer game shop has largely been replaced by online interaction in forums, social media, or in other ways.

At the computer game store, the purchase experience included purchasing a tangible, physical item along with the digital content. Boxed copies of computer games frequently contained, in addition to the game software, other physical items associated with the game. Computer game boxes often contained elaborately printed color game manuals and maps. Console games also often contained toys or action figures within their packaging. Record albums often came with fold out posters. All these physical items provided the purchaser with a tangible thing to associate with their purchase. Purchasing the physical boxed copy along with the associated physical items enabled the enthusiast to display their purchased physical item while enjoying their purchased content, frequently increasing the enjoyment and satisfaction received from the purchased content. Thus, users who acquired digital content realized a “boxed experience” that may have included carrying the box home or to a friend's house, opening the shrink-wrapped package, and playing with an action figure. Digital downloads typically do not produce the same physical experience.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example methods and apparatus are directed toward realizing the boxed experience for digital content acquisition. Example methods and apparatus may associate digital metadata with a digital content purchase. The digital metadata may describe a physical item. Example methods and apparatus may include the digital metadata with the digital content purchase to facilitate and control re-creation of the physical item from the digital metadata. Acquiring the re-created physical item replicates at least part of the experience of purchasing a physical version of the digital content. Example methods and apparatus may limit the number of times the physical item may be re-created, or may limit the frequency with which the physical item may be re-created. Example methods and apparatus may also make additional digital metadata selectively available at different times during the execution of a computer game or a video game. Similarly, additional digital metadata may be made available at different times during the playback of digital media content.

Some embodiments of example apparatus may include a set of logics (e.g., circuits). An association logic may control a processor to associate digital metadata with a digital content purchase. A re-creation logic may control the processor to control a rendering device to manufacture the physical item described by the digital metadata. The rendering device may be located in a location dedicated to the manufacturing of the physical item. A digital rights management logic may limit the manufacturing of the physical item from the digital metadata.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example embodiment of a computer game box and contents.

FIG. 2 illustrates an example method associated with realizing the boxed experience for digital content acquisition.

FIG. 3 illustrates an example method associated with realizing the boxed experience for digital content acquisition.

FIG. 4 illustrates an example method associated with realizing the boxed experience for digital content acquisition.

FIG. 5 illustrates an example apparatus associated with realizing the boxed experience for digital content acquisition.

FIG. 6 illustrates an example apparatus in an example operating environment.

FIG. 7 illustrates an example cloud operating environment in which methods or apparatus may facilitate realizing the boxed experience for digital content acquisition.

FIG. 8 is a system diagram depicting an exemplary mobile communication device configured to realize the boxed experience for digital content acquisition.

### DETAILED DESCRIPTION

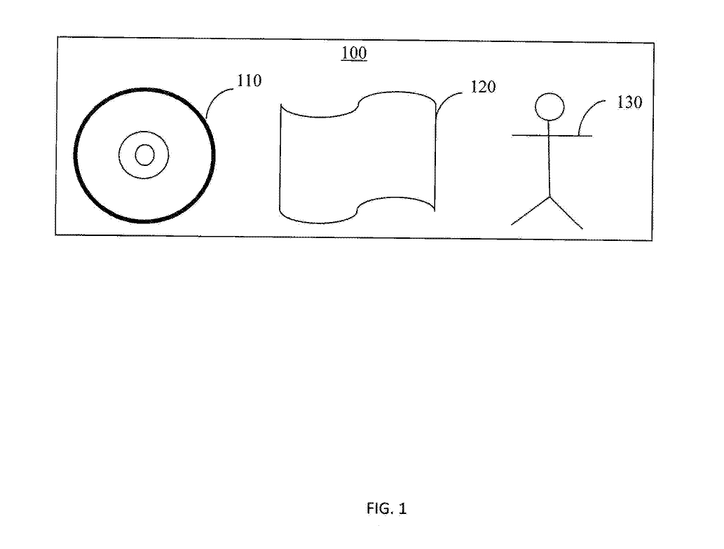

FIG. 1 illustrates an example boxed computer game 100. Before the Internet was as pervasive and functional as it is today, purchasers of computer games would frequently visit a dedicated brick and mortar computer game store to purchase physical boxed copies of computer games. The purchaser of a physical boxed copy of a computer game would often receive the game disk 110 containing the software to execute the game on a personal computer. There may also have been other physical items in the box. The physical items were often associated with the computer game's content. For example, boxed computer game 100 may have contained a game disk 110 imprinted with a color label illustrating a monster encountered in the computer game, a map 120 of the virtual world portrayed in the computer game, or a statute 130 of a character portrayed in the computer game. Map 120 may have been a fold-out color map that was larger and of higher quality than could be printed on printers commonly owned by computer game purchasers. Map 120 may have been printed on or woven with textiles. Other physical items associated with the computer game may have been included in the boxed computer game 100. For example, boxed computer game 100 may have included an elaborately printed color manual, a badge, a crest, a fabric patch, a poster, a set of technical drawings, or other physical item. Computer game enthusiasts were often motivated to purchase physical boxed copies of computer games that included these extra physical items to increase their enjoyment of the computer game. Often computer game enthusiasts would pay more money to purchase a special edition of a computer game that included extra or limited edition physical items. Casual purchasers were also motivated by the promise of receiving bonus or special physical content along with the game disk.

Other media purchased in a tangible physical format may have included physical items associated with the media content. For example, records and CDs may have included fold-out posters or lyric sheets. Console video games may have included in their packaging action figures representing characters encountered within the video game. Books may have been packaged in boxed sets that included a map of the fictional world described in the book or a poster illustrating a character or setting from the book. Films or television programs stored on tape or other storage media may have included similar physical items within their packaging.

With the advent of the Internet as a ubiquitous mode of digital content delivery, the experience of purchasing digital content has changed. Users now infrequently receive a physical copy of their digital content. Users now rarely receive any extra physical items associated with their digital content purchase. Typically, users download a digital copy of a computer game to their personal computer or other electronic device. The computer game may be subject to digital rights management software that limits the number of times the user is permitted to install the software or the number of computers on which the software may be installed. While the user who downloads a digital copy of a computer game may experience an increase in efficiency due to not having to physically travel to a brick and mortar store to purchase a boxed copy of the computer game, the user's experience is radically different from the experience of purchasing a physical boxed copy that contains a physical item associated with the digital content.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

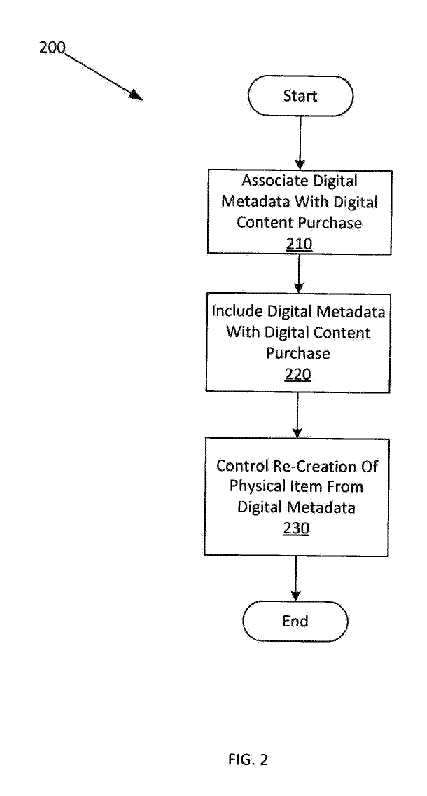

FIG. 2 illustrates an example method 200 associated with realizing the boxed experience of digital content acquisition. In different examples, method 200 may be performed on a single device, may be performed partially or completely in the cloud, may be performed on distributed co-operating devices, or may be performed in other ways. In different examples, method 200 may be performed on devices including, but not limited to, a computer, a laptop computer, a tablet computer, a phone, a Personal Electronic Device (PED) such as a smart phone, or other PED.

Method 200 includes, at 210, associating digital metadata with a digital content purchase. Associating the digital metadata with the digital content purchase may include establishing a link between the digital metadata and the digital content purchase, inserting the digital metadata into the digital content, packaging the digital metadata for delivery with the digital content purchase, adding the digital metadata to a file in which a portion of the digital content purchase resides, adding the metadata to an object in which a portion of the digital content purchase resides, updating a data store with the digital metadata, or other action. Establishing a link may include, for example, identifying a socket through which the digital metadata may be acquired, identifying a remote procedure call (RPC) interface through which the digital metadata may be acquired, providing a universal resource locator (URL) where the digital metadata can be acquired, or other action. Inserting the digital metadata into the digital content may include, for example, adding the digital metadata to a record, table, file, object, or other collection of data associated with the digital content.

In one example, the digital content purchase is a computer game. In another example, the digital content purchase is a console video game. In another example, the digital content purchase is an electronic book (e-book). In different examples, the digital content purchase may be a film, a television program, a piece of music, or other type of digital media content. In one example, the digital metadata describes a physical item associated with the digital content purchase. In one embodiment, the digital content purchase or digital metadata are subject to digital rights management (DRM) software. DRM software controls the use of the digital content purchase or digital metadata after the acquisition of the digital content by a user, by, for example, limiting the number of systems the digital content may be installed on, or by authenticating an installation of the digital content through an online connection with a DRM server. In one example, DRM software may limit the number of times or the frequency with which a physical item may be re-created from the digital metadata.

Method 200 includes, at 220, including the digital metadata with the digital content purchase. In one example, the digital metadata is included with the digital content as one file for download. In another example, the digital metadata is included with the digital content as a package of files for download. In one embodiment, including the digital metadata with the digital content purchase may involve packing the digital metadata with the digital content purchase in a record, table, object(s), file(s), binary large object(s), or other delivery mechanism. In another embodiment, including the digital metadata with the digital content purchase may involve making the digital metadata available for download from a known website from which the digital content purchase may be acquired, may involve embedding the digital metadata in the digital content purchase, or may involve providing a decryption key to facilitate accessing digital metadata that is pre-positioned in the digital content purchase. There are other ways to include digital metadata with a digital content purchase.

Method 200 includes, at 230, controlling re-creation of the physical item from the digital metadata. Re-creation of the physical item from the digital metadata replicates at least part of the experience a user may have of purchasing a physical boxed version of the digital content. In one embodiment, controlling re-creation may involve controlling a printer to print a copy of the physical item described by the digital metadata. The physical item printed may be, for example, a map, a poster, a game manual, a character record sheet, a sports trading card, a compact disk (CD) label, a CD case liner, a digital versatile disk (DVD) label, a DVD case cover, or other item. In another embodiment, controlling re-creation may involve controlling a three dimensional (3D) printer to print a three dimensional copy of the physical item based on the digital metadata. The three dimensional copy of the physical item may be, for example, a statue, an action figure, a model, a toy, or other item. In still another embodiment, an electronically controlled sewing machine may be controlled to stitch, weave, or sew a physical item described by the digital metadata. The stitched, woven, or sewn physical item may be, for example, an insignia, a badge, a crest, a patch, a map, or some other item.

In one embodiment of method 200, the digital metadata may describe a user-customizable avatar designed for use and operable within the computer game. For example, if the computer game is a life simulation game, the digital metadata may describe a user-customizable virtual person designed for use within the game that would otherwise not be available to other users of the game. The virtual person may be customized by the acquirer of the digital metadata to identify that particular virtual person as belonging to or representative of the acquirer of the digital metadata within the game. In another example, if the computer game is a hockey simulation game, the digital metadata may describe a user-customizable player otherwise unavailable to other users of the game. In another example, if the game is a flight simulator, the digital metadata may describe a user-customizable aircraft designed for use within the game. Method 200 may control, at 230, the re-creation of the user-customizable digital avatar. In one example, avatar editing software may be included with the digital content purchase. The avatar editing software may permit the user to customize the digital avatar for use within the computer game. For example, if the computer game is a flight simulator and the user-customizable digital avatar is a three-dimensional model of an aircraft for use within the simulation, the avatar editing software may allow the user to design or import a user-customized nose-art, skin (e.g., artistic outer covering), or other specialized markings for the aircraft. Additional user-customizable avatars designed for use within the computer game may be available in different games, depending on the genre, platform, game rating, or other characteristic of the game.

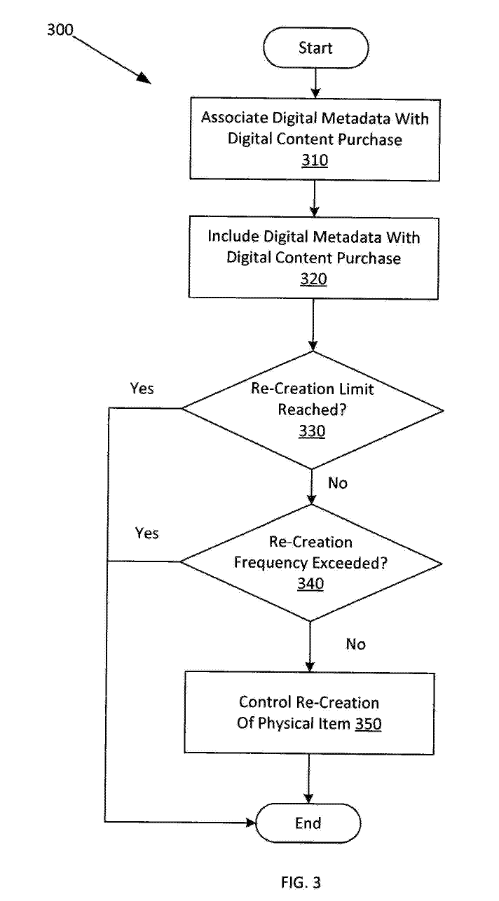

FIG. 3 illustrates an example method 300 that is similar to method 200 but includes additional actions at 330 and 340. Method 300 includes, at 310, associating digital metadata with a digital content purchase. Method 300 also includes, at 320, including the digital metadata with the digital content purchase.

Method 300 includes, at 330, determining if a re-creation limit has been reached. In one embodiment, the digital metadata includes information that defines a threshold limit to the number of times the physical item may be re-created from the digital metadata. In another embodiment, the digital content purchase includes the threshold limit. In another embodiment, the threshold limit is stored on a server or other location logically or physically separate from the digital metadata and digital content purchase. Thus, determining if a re-creation limit has been reached may include determining the number of times an item has been recreated and then accessing a separate piece of data that describes the limit. In different examples the limit may be found in the digital purchase content, in the digital metadata, on a server, on a computer, or elsewhere. In one embodiment, the digital metadata may limit the number of times the physical item may be re-created from the digital metadata to five times. For example, if method 300 determines at 330 that the physical item has been re-created more than a threshold number of times (e.g., five), then re-creation is prohibited and method 300 terminates. If, however, method 300 determines at 330 that the physical item has been re-created less than the threshold number of times, then method 300 proceeds to 340 to examine the re-creation frequency. While five times is described as the threshold number, in different embodiments a greater or lesser number of times may be employed as the threshold number.

Method 300 includes, at 340, determining if a re-creation frequency has been exceeded. In one embodiment, the digital metadata includes information defining a threshold re-creation frequency. In another embodiment, the threshold re-creation frequency is stored in the digital content purchase. In another embodiment, the threshold re-creation frequency is stored on a server or other location logically and physically separate from the digital metadata and digital content purchase. Thus, determining if a re-creation frequency has been exceeded may include determining the number of times the item has been created, the period of time over which the item has been created, and then accessing information that defines the threshold re-creation frequency. The threshold re-creation frequency may limit the frequency with which the physical item may be recreated. In one embodiment, the threshold re-creation frequency may be defined to restrict re-creation of the physical item from the digital metadata to twice over a twenty four hour period. In another example, the threshold re-creation frequency may be defined to restrict re-creation of the physical item from the digital metadata to once per hour. Other threshold re-creation frequencies may be defined. If the determination at 340 is that the threshold re-creation frequency has been exceeded, method 300 terminates. If, however, the determination at 340 is that the threshold re-creation frequency has not been exceeded, method 300 proceeds to 350.

Method 300 includes, at 350, controlling the re-creation of the physical item described by the digital metadata. Controlling re-creation may include, for example, controlling a printer, controlling a 3D printer, controlling a sewing machine, controlling a mold, controlling a lathe, or controlling another machine configured to produce the tangible, physical item described by the digital metadata.

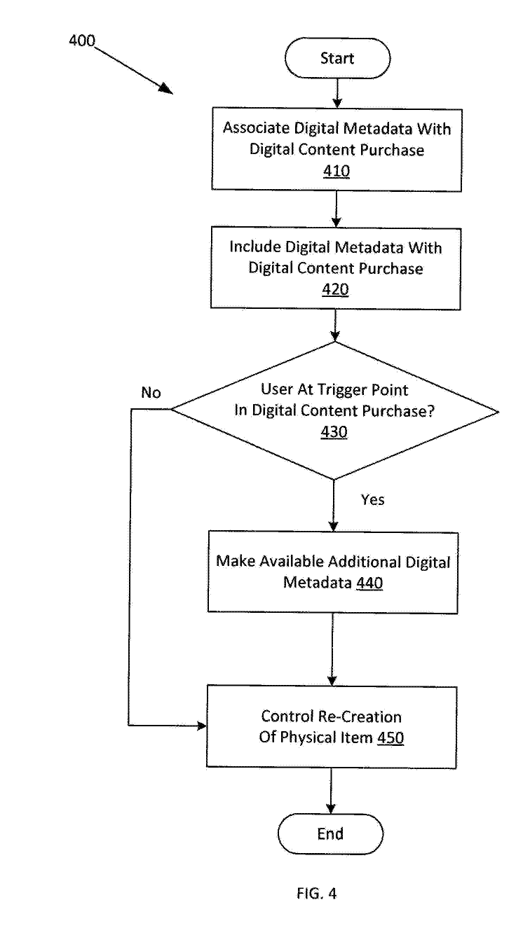

FIG. 4 illustrates an example method 400 that includes some actions similar to those found in methods 200 and 300. Method 400 includes, at 410, associating digital metadata with a digital content purchase. Method 400 also includes, at 420, including the digital metadata with the digital content purchase.

Method 400 also includes, at 430, determining whether a user has reached a trigger point associated with the digital content purchase. The trigger point may be, for example, reaching a certain point in a computer game. The computer game may be, for example, a console video game, a tablet computer game, a smart phone game, a flash game, or other game. In one embodiment, the trigger point may be reached when the user completes a threshold mission in the computer game. For example, when the user finishes “basic training” the user may be presented with additional digital metadata that allows the user to print out a single chevron representing a private first class. After the user finishes two years of virtual service or reaches a “master” level with a certain weapon the user may be presented with additional digital metadata that allows the user to print out a corporal's insignia. Thus, in one embodiment, metadata may be presented in a staged or staggered manner. In another embodiment, the trigger point may be reached upon the user achieving a threshold score within the computer game. For example, when the user scores a million points the user may be presented with metadata that facilitates printing out a “Million Point Club” memorabilia. In yet another embodiment, the trigger point may be reached upon the user completing a threshold percentage of the computer game. In another embodiment, the trigger point may be reached upon the user achieving a threshold level within the computer game. There are other trigger points that may be defined within a computer game, depending on the platform, genre, game rating, or other property of the game. Upon determining that the user has not reached a trigger point during the execution of the computer game, method 400 may terminate. If, however, the determination at 430 is that the user has reached a trigger point during the execution of the computer game, method 400 may proceed to 440.

In another embodiment, method 400 may include, at 430, determining if the user has reached a trigger point during the playback of an e-book, a film, or a television program. In one example, method 400 may determine if a user has watched a threshold percentage of the film or television program, or if the user has watched a trigger scene of the film or television program. If the user has watched the threshold percentage, the user may be provided metadata that facilitates producing a tangible item. In another embodiment, method 400 may include, at 430, determining if the user has read a threshold percentage of an e-book, or if the user has read a trigger scene of an e-book. Upon determining that the user has not watched a threshold percentage or a trigger scene of the film or television program, method 400 may terminate. In another example, upon determining that the user has not read a threshold percentage of an e-book or read a trigger scene of the e-book, method 400 may terminate. If, however, the determination at 430 is that the user has watched or read a threshold percentage of the film, television program, or e-book, of if the user has watched or read a trigger scene of the film, television program, or e-book, method 400 proceeds to 440.

Method 400 includes, at 440, making available additional digital metadata. In one embodiment, upon completing a threshold mission within the computer game, additional digital metadata comprising information describing an additional physical item associated with the completed threshold mission is made available to the user. For example, if the computer game is a fantasy role-playing game, upon completion of a threshold mission, the user may be rewarded with a newly revealed magical artifact. The additional digital metadata made available at 440 may include information describing the newly revealed magical artifact. In another embodiment, upon achieving a threshold score, additional digital metadata comprising information describing a physical item associated with the threshold score may be made available to the user. For example, if the computer game is a car racing game, upon achieving a threshold score the user may be rewarded within the game with a previously unavailable model race car. The user may be able to play the game with the newly available model race car and may receive metadata from which a tangible, physical copy of the model race car may be printed by, for example, a 3D printer. The additional digital metadata made available at 440 may include information describing the new model race car. In another embodiment, upon the user completing a threshold percentage of the computer game, additional digital metadata describing a physical item associated with the threshold percentage may be made available to the user. For example, if the computer game is a children's game involving virtual ponies, upon completing a threshold percentage of the game, the user may be rewarded within the game with a new virtual pony. The additional digital metadata may be information describing the new pony. The user may be able to ride the new pony in the game and may be able to print out a picture of the pony, print out stickers of the pony, have the pony stitched onto a hat, or may be able to control a 3D printer to print out a statue or action figure of the pony. The digital metadata may facilitate manufacturing other physical items using other apparatus (e.g., lathe, mold, loom). In another embodiment, upon completing a threshold level within the computer game, additional digital metadata describing a physical item associated with the threshold level may be made available to the user. For example, if the computer game is a military first-person shooter or strategy game, upon completion of a threshold level the user may be rewarded with a new suit of body armor within the game. The additional digital metadata made available at 440 may be information describing the new suit of body armor. In one embodiment, additional digital metadata may facilitate printing a t-shirt with a representation of the new suit of body armor. Other physical representations of the new suit of body armor may be produced.

In another embodiment, method 400 includes, at 440, making available additional digital metadata describing additional physical items. The digital content purchase may be an e-book, a film, or a television program. In one embodiment, the additional digital metadata made available at 440 may describe a map of a location described in the e-book. In another embodiment, the additional digital metadata may describe a statue of an item portrayed in the film. In still another embodiment, the additional digital metadata may describe an action figure of a character portrayed in the television program. The additional digital metadata may be suitable for controlling a printer or other rendering device that may produce the map, statue or other item.

Method 400 also includes, at 450, controlling the re-creation of the physical item based on the digital metadata. In one embodiment, method 400 may, at 450, control a printer or 3D printer to print a copy of the physical item described by the additional digital metadata. In another embodiment, method 400 may, at 450, control a sewing machine to stitch, embroider, knit, or otherwise fabricate a physical copy of the physical item described by the additional digital metadata. In still another embodiment, method 400 may, at 450, control a manufacturing device, including but not limited to a printer, a 3D printer, or a sewing machine, to emboss, engrave, print, or stitch an identifying mark on the physical item. In one example, the identifying mark may identify the physical item as belonging to the user. In another example, the identifying mark may include information identifying the copyright or trademark holder of the physical item described by the digital metadata. In one embodiment, the identifying mark may indicate visually whether the re-creation limit has been reached. For example, if the re-creation limit is 9, and the physical item has been printed 7 times, the characters “7 of 9” may be printed on the physical item.

While FIGS. 2, 3, and 4 illustrate various actions occurring in serial, it is to be appreciated that various actions illustrated in FIGS. 2, 3, and 4 could occur substantially in parallel. By way of illustration, a first process could determine if a user is at a trigger point in a computer game, a second process could determine if a re-creation limit has been reached, and a third process could determine if a re-creation frequency has been exceeded. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including method 200, method 300, or method 400. While executable instructions associated with the listed methods are described as being stored on a computer-readable storage medium, it is to be appreciated that executable instructions associated with other example methods described or claimed herein may also be stored on a computer-readable storage medium. In different embodiments the example methods described herein may be triggered in different ways. In one embodiment, a method may be triggered manually by a user. In another example, a method may be triggered automatically.

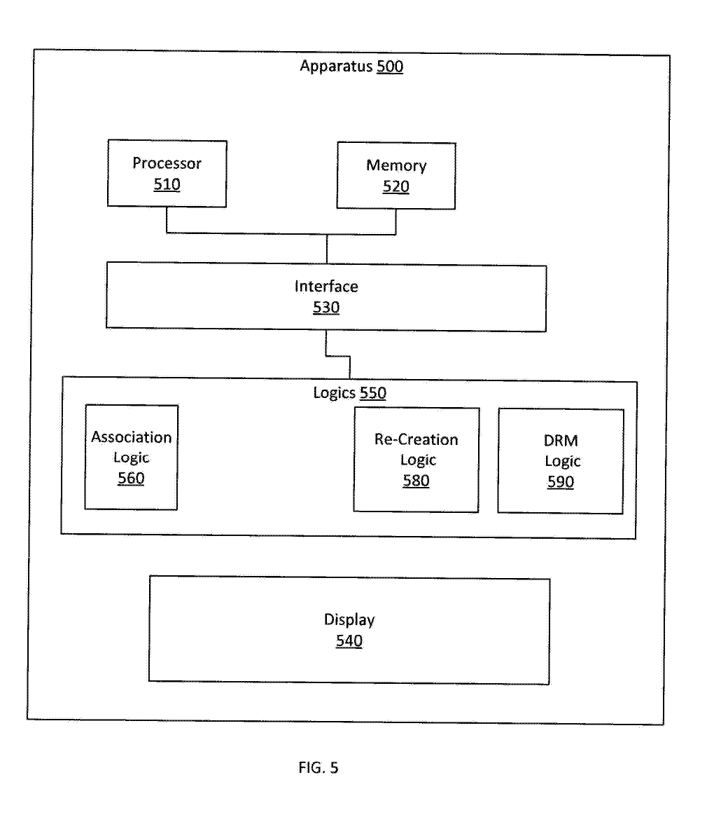

FIG. 5 illustrates an apparatus 500 associated with realizing or simulating at least a portion of the boxed experience for a digital content acquisition. In one example, the apparatus 500 includes an interface 530 configured to connect a processor 510, a memory 520, a display 540, and a set of logics 550. Elements of the apparatus 500 may be configured to communicate with each other, but not all connections have been shown for clarity of illustration.

Apparatus 500 may include an association logic 560. Association logic 560 may be configured to associate purchased digital media with digital metadata. Associating the digital metadata with the digital content purchase may include establishing a link between the digital metadata and the digital content purchase. Establishing the link may include, for example, identifying a socket, identifying a remote procedure call, identifying a resource locator, or other action. Associating the digital metadata with the digital media may include inserting the digital media into the digital content. Inserting the digital metadata into the digital content may include, for example, adding the digital metadata to a file in which a portion of the digital content purchase resides, adding the metadata to an object in which a portion of the digital content purchase resides, or adding the digital metadata to another collection of data (e.g., record, table, binary large object (BLOB)) that provides the purchased digital media. Associating the digital metadata may also include, for example, updating a data store with the digital metadata, packaging the digital metadata for delivery with the digital content purchase, or other action.

In one embodiment, the digital media may be a computer game, a video game, an e-book, a movie, or a television program. The digital metadata may describe a physical item. For example, the digital media may be a computer sports game and the digital metadata may describe a trophy awarded within the game world. Another copy of the computer sports game purchased by a different user may have digital metadata describing a different trophy associated with it by association logic 560. In another example, the digital media may be a television program and the digital metadata may describe a map of the island location upon which the television program is set. In one example, association logic 560 is configured to control the processor 510 to associate digital metadata with the digital media. Associating the digital metadata with the digital media may include, for example, inserting the digital metadata into the digital media, providing a decryption key for using the digital metadata, unlocking the digital metadata on a metadata server, placing the digital metadata into a file, object, or binary large object (BLOB) that will be used to deliver the digital media, or other actions.

In one example, association logic 560 controls processor 510 to include in one file the digital media and the digital metadata associated with the digital media. In another example, association logic 560 may be configured to control processor 510 to include the digital media and the digital metadata associated with the digital media in a package of files to be communicated.

Apparatus 500 may include re-creation logic 580. Re-creation logic 580 may be configured to control a physical rendering device to manufacture a physical item described by the digital metadata. In one embodiment, re-creation logic 580 may control a 3D printer to print a 3D copy of the physical item described by the digital metadata. In another example, re-creation logic 580 may control a sewing machine to stitch, embroider, knit, weave, or otherwise fabricate a physical copy of the physical item described by the digital metadata. In another embodiment, re-creation logic 580 may control a printer to print a copy of the physical item described by the digital metadata. In another embodiment, re-creation logic 580 may control processor 510 to control the physical rendering device to manufacture the physical item described by the digital metadata. While a 3D printer, a printer, and a sewing machine are described, other apparatus (e.g., loom, mold, lathe, laser ablation device) that can fabricate a physical item may be controllable by re-creation logic 580.

Apparatus 500 may include a digital rights management (DRM) logic 590. In one embodiment, DRM logic 590 may be configured to limit the number of times the physical item may be manufactured from the digital metadata. In one example, the DRM logic 590 may limit the number of times a championship trophy awarded in a computer sports game may be manufactured to ten times. In another embodiment, DRM logic 590 may be configured to control the frequency with which the physical item may be manufactured from the digital metadata. For example, DRM logic 590 may control the frequency with which a mission completion badge may be manufactured from digital metadata associated with a computer submarine simulation game to once per completion of the mission. Limiting the number of times the physical item may be manufactured may include, for example, tracking the number of times the physical item has been manufactured and selectively preventing digital metadata from being accessed if the number exceeds the threshold. Limiting the number of times the physical item may be manufactured may also include, for example, tracking the number of times the physical item has been manufactured and deleting, locking, encrypting or otherwise making the digital metadata unavailable for further usage. In one embodiment, the DRM logic 590 may be located in the apparatus 500. In another embodiment, the DRM logic 590 may interact with a DRM server located off-premises (e.g., in the cloud).

Apparatus 500 may include a memory 520. Memory 520 can include non-removable memory or removable memory. Non-removable memory may include random access memory (RAM), read only memory (ROM), flash memory, a hard disk, or other memory storage technologies. Removable memory may include flash memory, or other memory storage technologies, such as “smart cards.” Memory 520 may be configured to store digital metadata or a digital media purchase. The digital metadata may be associated with a digital media purchase by association logic 560. In one example, the digital metadata may describe a physical item associated with the digital media.

Apparatus 500 may include a processor 510. Processor 510 may be, for example, a signal processor, a microprocessor, an application specific integrated circuit (ASIC), or other control and processing logic circuitry for performing tasks including signal coding, data processing, input/output processing, power control, or other functions. Processor 510 may be configured to associate digital metadata with digital media. For example, processor 510 may be controlled by association logic 560 to associate digital metadata describing a physical item with digital media.

Processor 510 may also be configured to include digital metadata with digital media associated with the digital metadata by association logic 560. Processor 510 may also be configured to control a physical rendering device to manufacture the physical item described by the digital metadata. In one embodiment, processor 510 may be controlled by re-creation logic 580 to control the physical rendering device.

In one example, display 540 may be a digital multifunction display. In another embodiment, display 540 may be a cathode ray tube (CRT) display, a liquid crystal display (LCD), a light emitting diode (LED) display, or other type of display that may be operable with processor 510 and the set of logics 550. Display 540 may be controlled by the set of logics 550. Association logic 560 may be configured to control the display 540 to display the digital metadata to be associated with the digital media purchase. Association logic 560 may be configured to control the display 540 to display the digital metadata to be included with the digital media purchase. Re-creation logic 580 may be configured to control the display 540 to display information about the physical rendering device used to manufacture the physical item described by the digital metadata.

In one embodiment, the apparatus 500 may be a general purpose computer that has been transformed into a special purpose computer through the inclusion of the set of logics 550. The set of logics 550 may be configured to perform input and output. Apparatus 500 may interact with other apparatus, processes, and services through, for example, a computer network.

In one embodiment of apparatus 500, the digital metadata may describe a user-customizable digital avatar operable within a computer game or video game associated with the digital metadata. In one example, the digital metadata may describe a character playable by the user within the game. In another example, the digital metadata may describe a digital representation of a vehicle operable by the user within the game. In one example, the user-customizable digital avatar comprises a digital representation of the physical item portrayed in the computer game or video game. In one embodiment, additional digital metadata is available at different points or stages encountered by a user during the execution of the computer game or console video game. For example, the different points or stages may be encountered upon the user achieving a threshold score in the computer game, upon the user achieving a threshold level within the computer game, upon the user completing a threshold mission within the computer game, upon the user completing a threshold percentage of the computer game, or upon reaching some other trigger point during the execution of the computer game. In another example, similar points or stages may be encountered during the execution of a console video game. Thus, in one example, at a first point a user may receive metadata that facilitates printing out a pony and at a second later point the user may receive additional metadata that facilitates printing out an accessory for the pony.

In another embodiment of apparatus 500, additional digital metadata may be made available during playback of acquired digital media, where the acquired digital media is a film, a television program, or an e-book. For example, the additional digital metadata may be made available upon watching or reading a threshold percentage of the acquired digital media. In another embodiment, the additional digital metadata may be provided upon playback or reading of a trigger scene in the digital media. Additional digital metadata may be provided upon other conditions being met during the playback or reading of the digital media. For example, upon watching a threshold episode of an anime television program involving giant mechanical robots, additional digital metadata may be made available describing an action figure of a newly encountered giant mechanical robot. In another example, upon reading a threshold chapter of an e-book set in a fictional universe related to a table-top miniature science fiction game, additional digital metadata describing a character encountered in the threshold chapter may be provided, where the additional digital metadata enables the user to print a 3D model of the character.

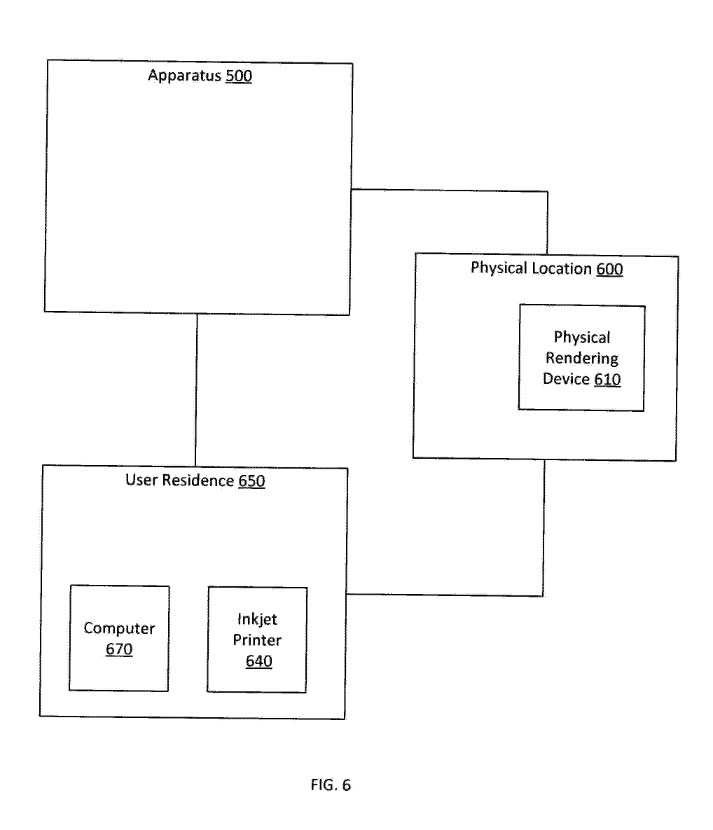

FIG. 6 illustrates one embodiment of apparatus 500 in action. A physical rendering device 610 may be located at a physical location 600 dedicated to or associated with the manufacture of the physical item associated with the digital metadata included with the purchased digital media. Location 600 may be, for example, an electronics store, a store operated by a digital media publisher, a foundry, a textile mill, a 3D printer equipped factory, or other location. Locating the physical rendering device 610 at location 600 operated by the digital media publisher or electronics retailer may enable the physical rendering device 610 to be of a higher quality than that available to the user alone. For example, while a user may have access to an inkjet printer 640 located at residence 650, the physical rendering device 610 at the store at location 600 may be a 3D printer that can print at a higher resolution, in more dimensions, and with greater detail than the user's inkjet printer 640. In one embodiment, a user may execute a computer game provided as the purchased digital media. The computer game may have associated digital metadata on a computer 670 located at residence 650. The physical rendering device 610 may be located at a location 600 that is operated by a digital media publisher or electronics retailer. The digital metadata may be transmitted to the physical rendering device 610 via the Internet, via a WI-FI network, via a local area network, by a flash memory stick, or in other ways. In one example, apparatus 500 may be configured to communicate via the Internet or over another network with the physical rendering device 610 located at the store and with the computer 670.

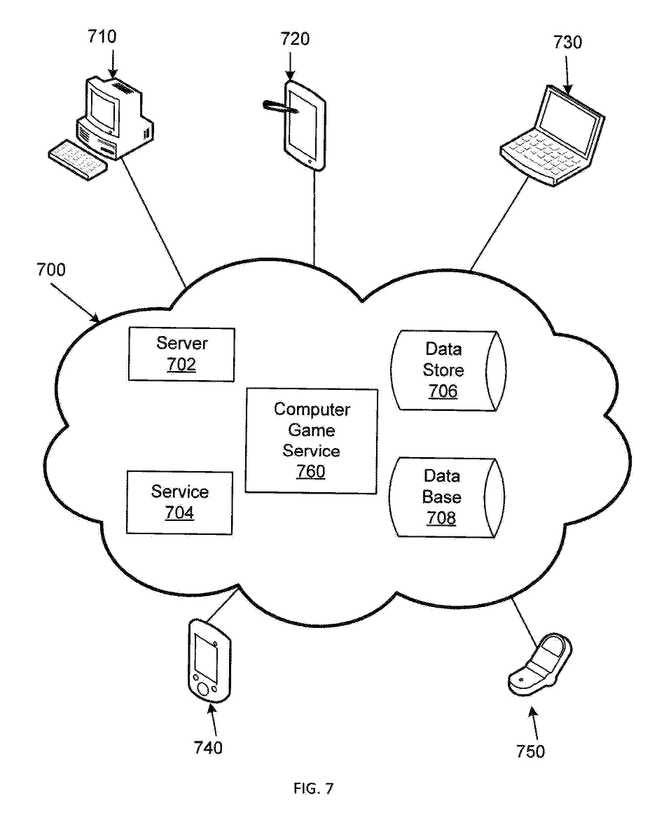

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example computer game service 760 residing in the cloud. The computer game service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the computer game service 760.

FIG. 7 illustrates various devices accessing the computer game service 760 in the cloud. The devices include a computer 710, a tablet 720, a laptop computer 730, a personal digital assistant 740, and a mobile device (e.g., cellular phone, satellite phone) 750.

It is possible that different users at different locations using different devices may access the computer game service 760 through different networks or interfaces. In one example, the computer game service 760 may be accessed by a mobile device 750. In another example, portions of computer game service 760 may reside on a mobile device 750. Computer game service 760 may perform actions including, for example, providing user information (e.g., digital content purchase identification, platform type), associating digital metadata with a digital content purchase, including digital metadata with a digital content purchase, controlling the re-creation of a physical item or user customizable digital avatar based on the digital metadata, computing values (e.g., number of times the physical item or digital avatar has been re-created from the digital metadata, frequency with which the physical item or digital avatar has been re-created), providing display values (e.g., number of times remaining to re-create the physical item or digital avatar, next point in time at which the physical item or digital avatar may be re-created, price to purchase rights to re-create the physical item additional times), or other actions.

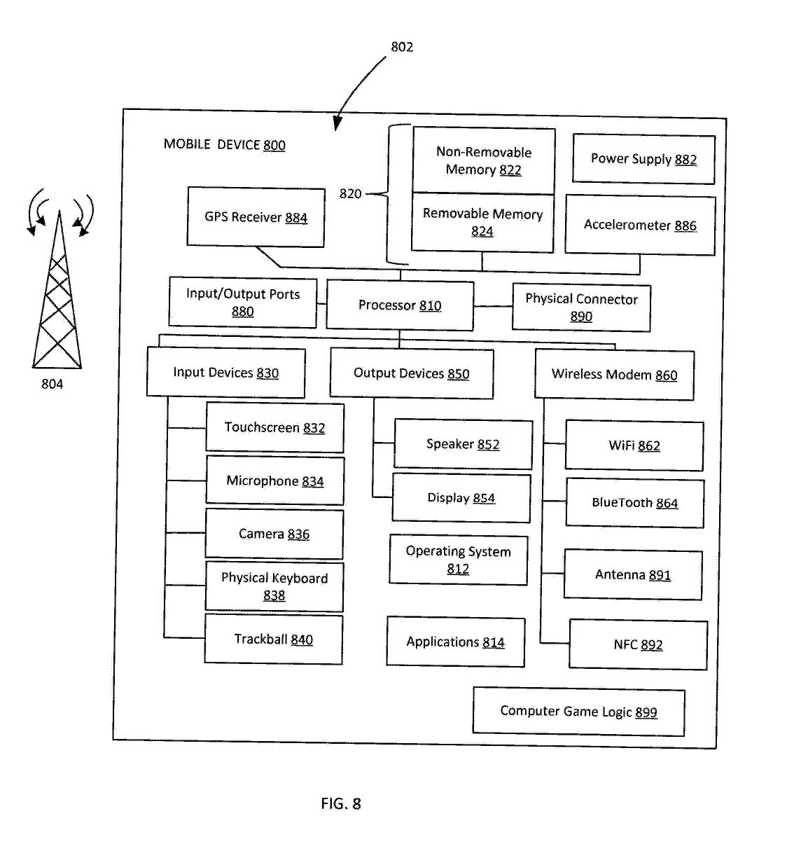

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), etc.) and may allow wireless two-way communications with one or more mobile communications networks 804, such as a cellular or satellite networks.

Mobile device 800 can include a controller or processor 810 (e.g., signal processor, microprocessor, ASIC, or other control and processing logic circuitry) for performing tasks including signal coding, data processing, input/output processing, power control, or other functions. An operating system 812 can control the allocation and usage of the components 802 and support application programs 814. The application programs 814 can include mobile computing applications (e.g., metadata control and distribution applications, email applications, calendars, contact managers, web browsers, messaging applications), or other computing applications.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is known in GSM communication systems, or other memory storage technologies, such as “smart cards.” The memory 820 can be used for storing data or code for running the operating system 812 and the applications 814. Example data can include purchased digital content, metadata describing physical items associated with the purchased digital content, web pages, text, images, sound files, video data, or other data sets to be sent to or received from one or more network servers or other devices via one or more wired or wireless networks. The memory 820 can store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible input devices (not shown) include accelerometers (e.g., one dimensional, two dimensional, three dimensional). Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can comprise speech-recognition software as part of a voice user interface that allows a user to operate the device 800 via voice commands. Further, the device 800 can include input devices and software that allow for user interaction via a user's spatial gestures, such as detecting and interpreting gestures to provide input to a gaming application.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). Mobile device 800 may also communicate locally using, for example, near field communication (NFC) element 892.

The mobile device 800 may include at least one input/output port 880, a power supply 882, a satellite navigation system receiver 884, such as a Global Positioning System (GPS) receiver, an accelerometer 886, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include a computer game logic 899 that is configured to provide a functionality for the mobile device 800. For example, computer game logic 899 may provide a client for interacting with a service (e.g., service 760, FIG. 7). Computer game logic 899 may associate digital metadata with a digital content purchase, may include digital metadata with a digital content purchase, may control re-creation of a physical item described by the digital metadata, may compute the number of times the physical item has been re-created and the frequency with which the physical item has been re-created, or may perform other actions. Portions of the example methods described herein may be performed by computer game logic 899. Similarly, computer game logic 899 may implement portions of apparatus described herein.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), other optical medium, a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
associating digital metadata with a digital content purchase, where the digital metadata describes a physical item related to the digital content purchase and usable separate from the digital content purchase;
including the digital metadata with the digital content purchase, and
controlling re-creation of the physical item from the digital metadata, where acquiring the physical item facilitates realizing at least part of an experience of purchasing a version of the digital content in a physical package.

2. The method of claim 1, the digital content purchase being a computer game, a video game, an e-book, a movie, or a television program.

3. The method of claim 1, the physical item being an action-figure, a statue, a toy, a map, a badge, a crest, a fabric design, a compact disk (CD) label, a CD case liner, a digital versatile disk (DVD) label, a DVD case label, or a DVD case liner.

4. The method of claim 1, where controlling re-creation of the physical item comprises limiting the number of times the physical item may be re-created from the digital metadata.

5. The method of claim 4, where controlling re-creation of the physical item comprises limiting the frequency with which the physical item may be re-created from the digital metadata.

6. The method of claim 1, where re-creating the physical item from the digital metadata comprises controlling a printer to print the physical item, or controlling a sewing machine to stitch the physical item.

7. The method of claim 6 where the printer is a three dimensional (3D) printer.

8. The method of claim 2, where the digital metadata describes a user-customizable digital avatar designed for use and operable within the computer game, and where the user-customizable avatar is a digital representation of the physical item.

9. The method of claim 1, where associating the digital metadata with the digital content purchase includes establishing a link between the digital metadata and the digital content purchase, inserting the digital metadata into the digital content, packaging the digital metadata for delivery with the digital content purchase, adding the digital metadata to a file in which a portion of the digital content purchase resides, adding the metadata to an object in which a portion of the digital content purchase resides, or updating a data store with the digital metadata.

10. The method of claim 2, where additional digital metadata describing an additional physical item is made available during execution of the computer game when the user completes a threshold mission within the computer game, when the user achieves a threshold score within the computer game, when the user completes a threshold percentage of the computer game, or when the user achieves a threshold level within the computer game.

11. The method of claim 2, where additional digital metadata describing an additional physical item is made available at a different time or point during playback of the e-book, movie, or television program.

12. The method of claim 1, the digital metadata being subject to digital rights management (DRM).

13. The method of claim 1, where re-creating the physical item comprises embossing, engraving, printing, or stitching an identifying mark on the physical item.

14. A computer-readable storage medium storing computer-executable instructions that when executed by a computer cause the computer to perform a method, the method comprising:
associating digital metadata with a digital content purchase, where the digital metadata describes a physical item related to the digital content purchase and usable separate from the digital content purchase, where associating the digital metadata with the digital content purchase includes establishing a link between the digital metadata and the digital content purchase, inserting the digital metadata into the digital content, packaging the digital metadata for delivery with the digital content purchase, adding the digital metadata to a file in which a portion of the digital content purchase resides, adding the metadata to an object in which a portion of the digital content purchase resides, or updating a data store with the digital metadata;
including the digital metadata with the digital content purchase, and
controlling re-creation of the physical item from the digital metadata,
where the digital content purchase is a computer game, an e-book, a movie, or a television program,
where the physical item is an action-figure, a statue, a toy, a map, a badge, a crest, a fabric design, a CD label, a DVD case label, or a CD case liner,
where controlling re-creation of the physical item includes limiting the number of times the physical item may be re-created from the digital metadata, or limiting the frequency with which the physical item may be re-created from the digital metadata,
where re-creating the physical item from the digital metadata includes controlling a three-dimensional printer to print the physical item in three dimensions, controlling a printer to print the physical item, or controlling a sewing machine to stitch the physical item,
where the digital metadata is subject to digital rights management, and
where acquiring the physical item facilitates realizing at least a portion of an experience associated with purchasing a physically packaged version of the digital content.

15. An apparatus, comprising:
a processor;
a memory;
a display;
a set of logics; and
an interface configured to connect the processor, the memory, the display, and the set of logics;
the set of logics comprising:
an association logic configured to associate digital metadata with acquired digital media;
a re-creation logic configured to control manufacturing a physical item from the digital metadata, and
a digital rights management logic configured to limit the manufacturing of the physical item,
where the digital metadata describes a physical item, and
where the acquired digital media is a computer game, a video game, an e-book, a movie, or a television program.

16. The apparatus of claim 15, the re-creation logic being configured to control a physical rendering device to render the physical item.

17. The apparatus of claim 16, the physical rendering device being located at a site dedicated to the manufacture of the physical item associated with the acquired digital media.

18. The apparatus of claim 15, the digital metadata describing a user-customizable digital avatar operable within the computer game or the video game, the user-customizable digital avatar being a digital representation of the physical item, and where the association logic makes available additional digital metadata at different points or stages including upon achieving a threshold score in the computer game, upon achieving a threshold level in the computer game, upon completing a mission within the computer game, or upon reaching a trigger point within the computer game.

19. The apparatus of claim 15, the association logic being configured to provide additional digital metadata at times including:
during playback of the movie upon determining that a threshold percentage of the movie has been watched,
during playback of the movie upon determining that a trigger scene has been watched,
during playback of the television program upon determining that a threshold percentage of the television program has been watched,
during playback of the television program upon determining that a trigger scene has been watched,
during reading of the e-book upon determining that a threshold percentage of the e-book has been read, or
during reading of the e-book upon determining that a trigger scene in the e-book has been read.

20. The apparatus of claim 15, the digital rights management logic being configured to limit the number of times the physical item may be manufactured from the digital metadata, and to control the frequency with which the physical item may be manufactured from the digital metadata.
